(19) United States
(12) Patent Application Publication
(10) Pub. No.: US 2005/0246419 A1
(43) Pub. Date: Nov. 3, 2005

(54) Method for proving a communications network subscriber with an anonymous temporary subscriber identity and a dual anonymous communication system

(76) Inventor: Mikael Jaatinen, Turku (FI)

Correspondence Address: NIXON & VANDERHYE, PC, 901 NORTH GLEBE ROAD, 11TH FLOOR, ARLINGTON, VA, 22203, US

(21) Appl. No.: 10/511,849

(22) PCT Filed: Feb. 28, 2003
(86) PCT No.: PCT/FI03/00147

§ 371 Date: Nov. 17, 2004

(30) Foreign Application Priority Data
Apr. 30, 2002 (FI) 20020818

(51) Int. Cl. G06F 15/16

(52) U.S. Cl. 709/204

(57) ABSTRACT

The present invention describes a communications network based method for providing a communications network subscriber using SIP signalling for communication path set up with an anonymous temporary identity and a dual anonymous communication system. In the solution according to the present invention a subscriber can reserve a temporary subscriber identity or even several temporary subscriber identities. The temporary subscriber identity will be associated to the person's real phone number in the application server that handles dual anonymous communication in the communications network.

### TECHNICAL FIELD OF THE INVENTION

The present invention relates in general to communication networks and more specifically to a communications network based method for providing a communications network subscriber with an anonymous temporary subscriber identity and to a dual anonymous communication system.

### BACKGROUND OF THE INVENTION

The background of the invention is discussed briefly in the following.

With dual anonymous communication is meant communication between two parties, where neither originating nor terminating party knows the other party's real subscriber identity.

Today, the most typical and popular form of dual anonymous communication is anonymous chatting. One can do anonymous chatting on the Internet in several forums, GSM chat, on the TV, over GSM and other forums (GSM, Global System for Mobile communication). By ‘anonymous’ in this context is meant that the people in the chat forum do not (necessarily) know the real identity (name, e-mail address, phone number, etc.) of each other.

The problem arises when two parties in the chat forum want to talk to each other on the phone while still wanting to keep their identity secret from the other party.

One may imagine two persons A and B who don't know each other chatting either in the TV using SMS (SMS, Short Message Service) or on the Internet using aliases. They would like to call each other to arrange e.g. a date but both of them are too shy to give their real phone number or don't want to give the real number in case the other person turns out to be a troublemaker. This is especially true when the chat is going on in TV—as then lots of other people might see the real phone number and start harassing.

Already today there exists services that enable anonymous calls to voice chat rooms. It is also possible for the originating party to suppress his subscriber identity. Anonymous e-mail has also been possible for years. The originating party can also use Calling Line Identity Restriction to suppress his phone number.

There also exist today certain known technologies for anonymous communication. However, these are limited to certain services and apply on circuit-switched networks that are gradually being phased out as all communication (speech, data) is moving to IP based networks.

Nevertheless, in the IP based networks, there does not exist services that would enable anonymous calls between two parties, where neither calling nor called subscriber knows the other party's real subscriber identity.

Furthermore, there does not exist services that would enable dual anonymous one-to-one communication using the same account for all types of communication (e.g. voice, data, e-mail, etc.).

There is a need for a communications network based method for providing a communications network subscriber with an anonymous temporary subscriber identity and for a dual anonymous communication system. This need exists both in present circuit-switched wireline and wireless networks as well as in IP based networks.

The European patent application EP 984 608 shows, as referred to as a prior art, one solution relating to a call broker for providing telephone communications using online communication. The disclosed solution presents a solution, where in an on-line text chat environment-one can establishm a telephone link to one of the, chat participants with the help of a call broker equipment.

The IETF SIP WG Internet draft “SIP Extensions for Caller Identity and Privacy” by Marshall et al. shows, as referred to as a prior art, extensions to SIP that enable parties in a SIP session to be identified by different types of party information, which are authenticated by a trusted entity. The specification draft shows solutions, where delivery of party information can be suppressed.

The prior art solutions do not present a solution for a communications network based method for providing a communications network subscriber with an anonymous temporary subscriber identity or a solution for a dual-anonymous communication system.

### SUMMARY OF THE PRESENT INVENTION

It is an object of the present invention to overcome or at least mitigate the disadvantages of the prior art. The present invention realizes a communications network based method for providing a communications network subscriber with an anonymous temporary subscriber identity and a dual anonymous communication system.

According to a first aspect of the present invention there is presented a method for providing a subscriber with an anonymous subscriber identity, for use in an IP communications network having an originating party A and a terminating party B connected to the network, in which the method comprises the steps of
the terminating party B requesting a temporary SIP address (SIP, Session Initiation Protocol) to be used as an anonymous subscriber identity,
the IP communications network reserving a temporary SIP address to which the regular subscriber identity of the terminating party B is associated,
an application server providing the temporary SIP address to the terminating party B,
the terminating party B announcing the received temporary SIP address in an open forum,
the originating party A initiating an anonymous communication path towards the temporary SIP address of the terminating party B,
the originating party A suppressing the subscriber identity-in the communication path set up, and
the IP communications network establishing an anonymous communication path between the originating party A and the terminating party B for anonymous communication between two parties using any type of bearer available for communication between two parties in an IP based network, and using the subscriber identity of the terminating party B associated with the temporary SIP address.

Preferably, in the method according to present invention, the terminating party B requests the temporary SIP address via Internet. Alternatively, the terminating party B requests the temporary SIP address via an SMS-interface (SMS, Short Message Service). Alternatively, the terminating party B requests the temporary SIP address via a WAP-interface (WAP, Wireless Application Protocol). Alternatively, the terminating party B requests the temporary SIP address by dialing a number in the IP communications network. Alternatively, the terminating party B requests the temporary SIP address via an email-interface. Preferably, the terminating party B requests several temporary SIP addresses.

Preferably, in the method according to present invention, the terminating party B announces the received temporary SIP address in Television. Alternatively, the terminating party B announces the received temporary SIP address in a restricted open forum. More preferably, the restricted open forum is the service providing the temporary SIP address.

Preferably, in the method according to present invention, the terminating party B terminates the-temporary SIP address. Preferably, the the use of an temporary SIP address is disabled for a time period.

According to a second aspect of the present invention there is presented an arrangement for providing a subscriber with an anonymous subscriber identity, for use in an IP communications network having an originating party A and a terminating party B connected to the network, in which arrangement
the terminating party B having means for requesting a temporary SIP address (SIP, Session Initiation Protocol) to be used as an anonymous subscriber identity,
the IP communications network having means for reserving a temporary SIP address to which the regular subscriber identity of the terminating party B is associated,
an application server having means for providing the temporary SIP address to the terminating party B,
the terminating party B having means for associating his regular subscriber identity with the temporary SIP address,
the terminating party B having means for announcing the received temporary SIP address in an open forum,
a originating party A having means for initiating an anonymous communication path towards the temporary SIP address of the terminating party B,
a originating party A having means for suppressing the subscriber identity in the communication path set up, and
the IP communications network having means for establishing an anonymous communication path between the originating party A and the terminating party B for anonymous communication between two parties using any type of bearer available for communication between two parties in an IP based network, and using the subscriber identity of the terminating party B associated with the temporary SIP address.

Preferably, in the arrangement according to present invention, the terminating party B has means for requesting the temporary SIP address via Internet. Alternatively, the terminating party B has means for requesting the temporary SIP address via an SMS-interface (SMS, Short Message Service). Alternatively, the terminating party B has means for requesting the temporary SIP address via a WAP-interface (WAP, Wireless Application Protocol). Alternatively, the terminating party B has means for requesting the temporary SIP address by dialing a number in the IP communications network. Alternatively, the terminating party B has means for requesting the temporary SIP address via an email-interface. Preferably, the terminating party B has means for requesting several temporary SIP addresses.

Preferably, in the arrangement according to present invention, the terminating party B has means for announcing the received temporary SIP address in Television. Alternatively, the terminating party B has means-for announcing the received temporary SIP address in a restricted open forum. More preferably, the restricted open forum is the service providing the temporary SIP address.

Preferably, in the arrangement according to present invention, the terminating party B has means to terminate the temporary SIP address. Preferably, the use of an temporary SIP address is disabled for a time period.

### BRIEF DESCRIPTION OF THE DRAWINGS

For a better understanding of the present invention and in order to show how the same may be carried into effect reference will now be made to the accompanying drawings, in which:

FIG. 1 illustrates a dual anonymous communication system according to the present invention implemented in an IP based network.

FIG. 2 illustrates a method for providing a communications network subscriber with an anonymous temporary subscriber identity according to the present invention.

### DETAILED DESCRIPTION OF CERTAIN EMBODIMENTS

The present invention describes a generic solution for all types of dual anonymous communication in IP based networks (IP, Internet protocol) where communication paths are established with SIP signalling (SIP, Session Initiation Protocol). The present invention also describes how a dual anonymous communication service can be implemented in an IP based network by using anonymous temporary SIP addresses to provide anonymity for subscribers.

The solution according to the present invention presents a new communications network based method for providing a communications network subscriber with an anonymous temporary subscriber identity and a new dual anonymous communication system.

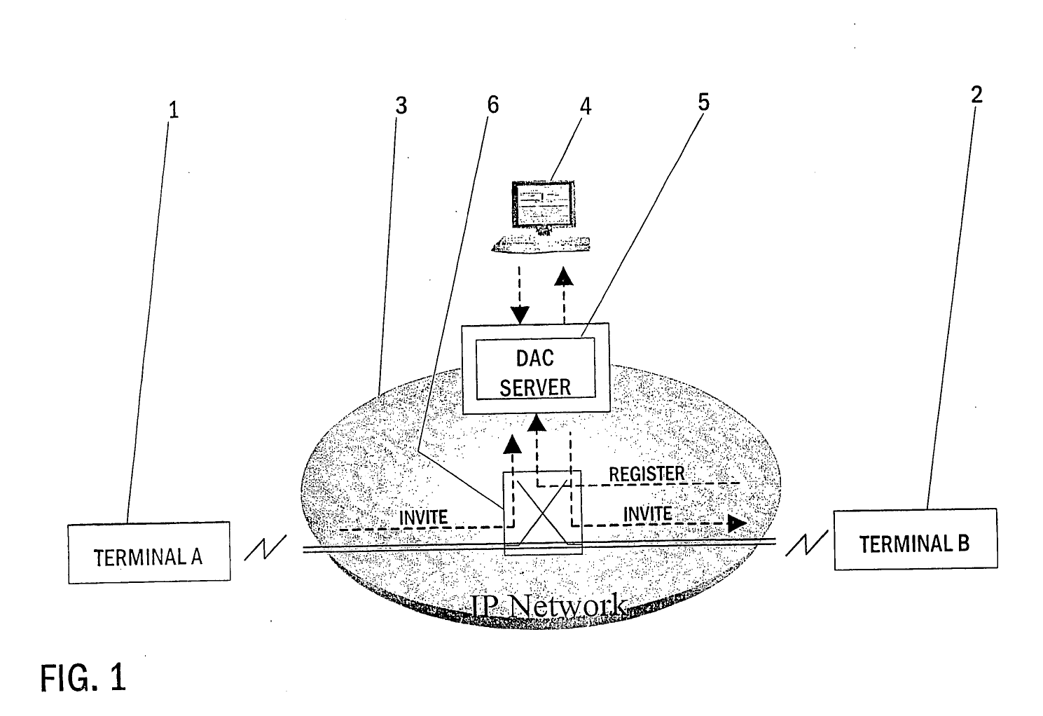

FIG. 1 illustrates a dual anonymous communication system according to the present invention implemented in an IP based Network. FIG. 1 shows how a Dual Anonymous Communication system is implemented as an IP network service using temporary subscriber identities allocated by subscribers. The dual anonymous communication system according to the present invention has a subscriber terminal A 1 and a subscriber B 2 connected to an IP based network 3. The dual anonymous communication system according to the present invention also has an application server named as DAC-server 5 (DAC, Dual Anonymous Communication) in the IP based network 3. Furthermore, the dual anonymous communication system according to the present invention has a PC 4 for a connection to the DAC-server 5 (PC, Personal Computer). A router in the IP network 3 is marked with a reference number 6.

Dual anonymous communication is enabled by reserving a pool of SIP-addresses (SIP, Session Initiation Protocol) for the Dual Anonymous Communication service in the DAC-server 5. These addresses are used as temporary network identification for dual anonymous communication. A subscriber can reserve a anonymous temporary SIP address in a DAC server 5 with a PC 4 over e.g. an IP connection. When a subscriber with an anonymous temporary SIP address connects to the IP based network, he/she associates the real subscriber identity (e.g. a regular SIP address) with the anonymous temporary SIP address in the DAC server 5 using SIP message REGISTER.

A dual anonymous connection is set up in the following way using SIP signalling. The originating subscriber A 1 contacts the DAC server 5 with INVITE message using a anonymous temporary SIP address associated to the terminating subscriber B 2. The DAC server 5 replaces the anonymous temporary SIP address with subscriber B's 2 original network identity and sends INVITE message towards the subscriber B 2.

As an alternative, the DAC server can suppress or remove the A-subscriber's network identity in/from the INVITE message sent by DAC server. Likewise, the DAC server 5 can replace the A-subscriber's original network identity with a generic DAC server identity or with a temporary network identity in case subscriber B 2 has subscribed to a anonymous temporary SIP address in the DAC server 5.

The solution according to the present invention is applicable to all types of bearers available for communication between two parties in an IP based network, for example email, voice calls, chat and real time video.

The anonymous temporary SIP address can be used for communication path set up as long as the originating and terminating subscriber want to be anonymous to each other, enabling the service provider to generate additional revenue. Usage of the service can be indicated using charging data collected for anonymous communication in the network.

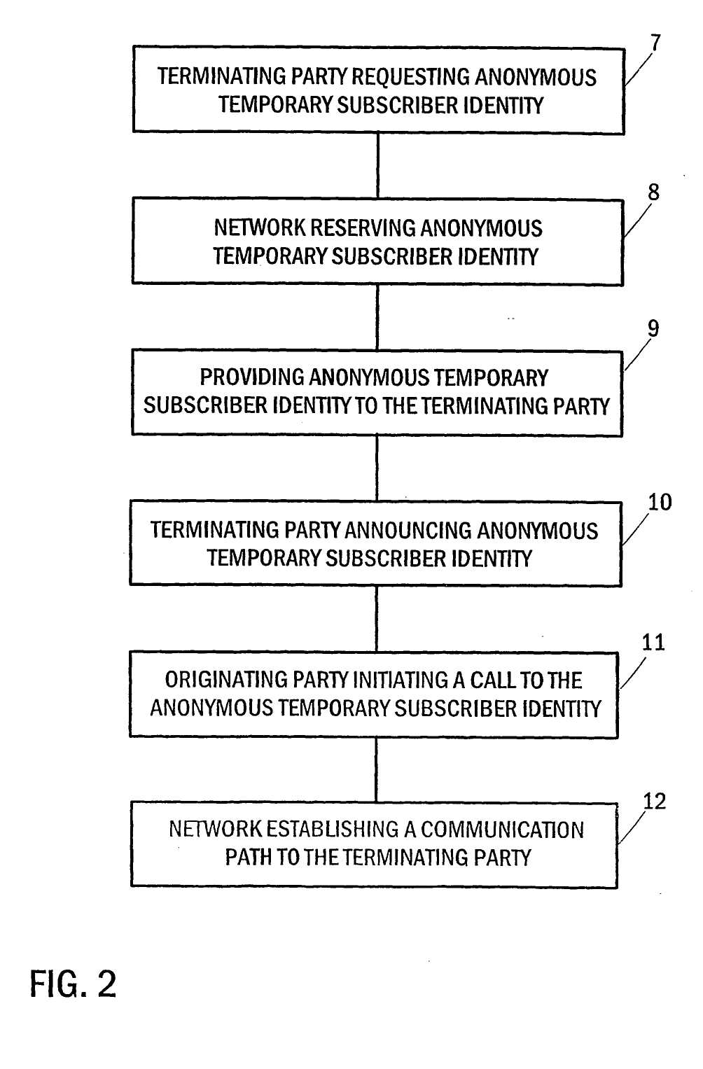

FIG. 2 illustrates a method for providing a communications network subscriber with an anonymous temporary subscriber identity according to the present invention. In the solution according to the present invention a subscriber requests 7 a temporary subscriber identity using web access or SMS. The DAC system then reserves 8 a temporary subscriber identity and replaces this with subscriber B's regular subscriber identity. The DAC system then provides 9 this temporary subscriber identity to the subscriber B. Subscriber B then announces 10 the temporary subscriber identity to the subscriber A. The originating subscriber A initiates 11 a call using the temporary number or sends an INVITE message 11 to the IP network using the anonymous temporary SIP address. The DAC system replaces the temporary subscriber identity with subscriber B's original network identity and routes the call 12 to the called party.

Considering the popularity of anonymous chatting on the Internet, TV and over GSM, this invention has big several implementation applications. The service is easy to implement and can be deployed in existing GSM/UMTS network in a very short timeframe. Also implementation cost in IP networks is low. This type of service could be advertised for example in Internet chat rooms and TV chat.

In the solution according to the present invention a subscriber can reserve a temporary subscriber identity or even several temporary subscriber identities using web access or SMS. The temporary subscriber identity will be associated to the person's regular subscriber identity in the SCP or in the IP Network.

B gives the temporary subscriber identity to A. Person A can then call the temporary subscriber identity reserved by B without actually knowing A's real subscriber identity. B on the other hand will not know A's identity if Calling Line Identity Restriction is applied for A. This is optional. If B doesn't want to have anything to do with A anymore, B can easily get rid of the temporary subscriber identity and possibly reserve a new temporary subscriber identity instead. This way, A has no way of calling B anymore. The pool of temporary subscriber identities has to be relatively big so that the time interval when the same temporary subscriber identity is reserved again is big enough.

Compared to using a calling card, the threshold to start using this kind of service is much lower. The service can be used with an ordinary subscription from anywhere. Chatting on TV and Internet is nowadays extremely popular. The service according to the present invention could be implemented on TV and Internet in chat forums.

1. A method for providing a subscriber with an anonymous subscriber identity, for use in an IP communications net-work having an originating party A and a terminating party B connected to the network, the method being characterized in that the method comprises the steps of
the terminating party B requesting a temporary SIP address to be used as an anonymous subscriber identity (7),
the IP communications network reserving a temporary SIP address to which the regular subscriber identity of the terminating party B is associated (8),
an application server providing the temporary SIP ad-dress to the terminating party B (9),
the terminating party B announcing the received temporary SIP address in an open forum (10),
the originating party A initiating an anonymous communication path towards the temporary SIP address of the terminating party B,
the originating party A suppressing the subscriber identity in the communication path set up, and
the IP communications network establishing an anonymous communication path between the originating party A and the terminating party B for anonymous communication between two parties using any type of bearer available for communication between two parties in an IP based network, and using the subscriber identity of the terminating party B associated with the temporary SIP address (12).

2. A method according to claim 1, characterized in that the terminating party B requests the temporary SIP address via Internet.

3. A method according to claim 1, characterized in that the terminating party B requests the temporary SIP address via an SMS-interface.

4. A method according to claim 1, characterized in that the terminating party B requests the temporary SIP address via a WAP-interface.

5. A method according to claim 1, characterized in that the terminating party B requests the temporary SIP address by dialing a number in the IP communications network.

6. A method according to claim 1, characterized in that the terminating party B requests the temporary SIP address via an email-interface.

7. A method according to claim 1, characterized in that the terminating party B requests several temporary SIP addresses.

8. A method according to claim 1, characterized in that the terminating party B announces the received temporary SIP address in Television.

9. A method according to claim 1, characterized in that the terminating party B announces the received temporary SIP address in a restricted open forum.

10. A method according to the claim 9, characterized in that the restricted open forum is the service providing the temporary SIP address.

11. A method according to claim 1, characterized in that the terminating party B terminates the temporary SIP address.

12. A method according to claim 1, characterized in that the use of an temporary SIP address is disabled for a time period.

13. An arrangement for providing a subscriber with an anonymous subscriber identity, for use in an IP communications network having an originating party A and a terminating party B connected to the network, the arrangement being characterized in that
the terminating party B having means for requesting a temporary SIP address to be used as an anonymous subscriber identity,
the IP communications network having means for reserving a temporary SIP address to which the regular subscriber identity of the terminating party B is associated,
an application server having means for providing the temporary SIP address to the terminating party B,
the terminating party B having means for associating his regular subscriber identity with the temporary SIP address,
the terminating party B having means for announcing the received temporary SIP address in an open forum,
a originating party A having means for initiating an anonymous communication path towards the temporary SIP address of the terminating party B,
a originating party A having means for suppressing the subscriber identity in the communication path set up, and
the IP communications network having means for establishing an anonymous communication path between the originating party A and the terminating party B for anonymous communication between two parties using any type of bearer available for communication between two parties in an IP based network, and using the subscriber identity of the terminating party B associated with the temporary SIP address.

14. An arrangement according to claim 13, characterized in that the terminating party B has means for requesting the temporary SIP address via Internet.

15. An arrangement according to claim 13, characterized in that the terminating party B has means for requesting the temporary SIP address via an SMS-interface.

16. An arrangement according to claim 13, characterized in that the terminating party B has means for requesting the temporary SIP address via a WAP-interface.

17. An arrangement according to claim 13, characterized in that the terminating party B has means for requesting the temporary SIP address by dialing a number in the IP communications network.

18. An arrangement according to claim 13, characterized in that the terminating party B has means for requesting the temporary SIP address via an email-interface.

19. An arrangement according to claim 13, characterized in that the terminating party B has means for requesting several temporary SIP addresses.

20. An arrangement according to claim 13, characterized in that the terminating party B has means for announcing the received temporary SIP address in Television.

21. An arrangement according to claim 13, characterized in that the terminating party B has means for announcing the received temporary SIP address in a restricted open forum.

22. An arrangement according to the claim 21, characterized in that the restricted open forum is the service providing the temporary SIP address.

23. An arrangement according to claim 13, characterized in that the terminating party B has means to terminate the temporary SIP address.

24. An arrangement according to claim 13, characterized in that the use of an temporary SIP address is disabled for a time period.
